(19) United States
(12) Patent Application Publication
(10) Pub. No.: US 2020/0136207 A1
(43) Pub. Date: Apr. 30, 2020

(54) HEAT CONDUCTING LITHIUM-ION BATTERY

(71) Applicant: CHANGSHA JUNENGCHONG NEW ENERGY CO., LTD, Changsha (CN)

(72) Inventor: BO-QIAN QIU, Changsha (CN)

(21) Appl. No.: 16/727,670

(22) Filed: Dec. 26, 2019

Related U.S. Application Data
(63) Continuation of application No. PCT/CN2018/093107, filed on Jun. 27, 2018.

(30) Foreign Application Priority Data
Jun. 28, 2017 (CN) 201710503605.6
Jun. 28, 2017 (CN) 201710503671.3

(51) Int. Cl. H01M 10/654; H01M 10/617; H01M 10/6552; H01M 10/6567; H01M 10/6556; H01M 10/6551; H01M 10/0525; H01M 10/48

(52) U.S. Cl. CPC H01M 10/654; H01M 10/617; H01M 10/6552; H01M 10/6567; H01M 10/625; H01M 10/6551; H01M 10/0525; H01M 10/486; H01M 2220/20; H01M 10/6556

(57) ABSTRACT

A heat conducting lithium-ion battery includes a battery cell including positive and negative electrode plates. The positive electrode plate includes a positive current collector and a positive active material layer coated on the positive current collector. The negative electrode plate includes a negative current collector and a negative active material layer coated on the negative current collector. At least one of the positive and negative electrode plates includes a heat conducting and collecting body which is a portion of the current collector not coated by the active material layer. At least two heat conducting and collecting bodies are stacked together to form at least one heat converging path, which allows heat energy to enter or exit from the battery cell. A fluid-containing pipe is connected to the at least one heat converging path.

### CROSS-REFERENCE TO RELATED APPLICATIONS

This application claims all benefits accruing under 35 U.S.C. § 119 from China Patent Application No. 201710503605.6, filed on Jun. 28, 2017, and China Patent Application No. 201710503671.3, filed on Jun. 28, 2017, in the China National Intellectual Property Administration, the entire contents of which is hereby incorporated by reference. This application is a continuation under 35 U.S.C. § 120 of international patent application PCT/CN2018/093107 filed Jun. 27, 2018.

### FIELD

The subject matter herein generally relates to lithium-ion batteries, and more particularly, to a heat conducting lithium-ion battery.

### BACKGROUND

Traffic on the roads brings pressure on the energy crisis and environmental pollution, thus it is urgent to develop and research efficient, clean and safe new energy vehicles to achieve energy conservation and emission reduction. Lithium-ion batteries have become the best candidates for power systems of the new energy vehicles because of high specific energy, no pollution, and no memory effect. However, the lithium-ion batteries are very sensitive to temperature, and efficient discharge and good performance of the battery pack can be only obtained within a suitable temperature range. At an elevated temperature may cause the lithium-ion battery to age faster and increase its thermal resistances faster. The cycle time becomes less, the service life becomes shorter, and even thermal runaway problems can occur at an elevated operating temperature. However, operating at too low a temperature may lower the conductivity of the electrolyte 40 and the ability to conduct active ions, resulting an increase of the impedance, and a decrease in the capacity of the lithium-ion batteries.

Conventionally, the position of the cell is changed to improve the fluid flow path and increase the heat dissipation. The battery casing may also be improved by replacing the aluminum alloy shell material with the composite of thermoelectric material and aluminum, and by adding a plurality of heat dissipating ribs to the side of the housing. The electrode plate may also be extended into the electrolyte 40 to transmit heat energy to the battery casing through the electrolyte 40 and then to the outside of the battery. Although some heat is dissipated, heat dissipation efficiency is still poor since the heat cannot be directly discharged from main heat generating component, the electrode plates, to the outside of the battery. Therefore, a new lithium-ion battery is needed.

### BRIEF DESCRIPTION OF THE DRAWINGS

FIG. 1 is a schematic view of a heat conducting lithium-ion battery in a first embodiment according to the present disclosure.

FIG. 2 is a cross-sectional view along line II-II of FIG. 1.

FIG. 3 is a schematic view of a heat conducting lithium-ion battery in a second embodiment according to the present disclosure.

FIG. 4 is a cross-sectional view along line IV-IV of FIG. 3.

FIG. 5 is a schematic view of a heat conducting lithium-ion battery in a third embodiment according to the present disclosure.

FIG. 6 is a schematic view of a heat conducting lithium-ion battery in a fourth embodiment according to the present disclosure.

FIG. 7 is a schematic view of a heat conducting lithium-ion battery in a fifth embodiment according to the present disclosure.

FIG. 8 is a schematic view of a heat conducting lithium-ion battery in a sixth embodiment according to the present disclosure.

FIG. 9 is a schematic view of a heat conducting lithium-ion battery in a seventh embodiment according to the present disclosure.

FIG. 10 is a cross-sectional view along line X-X of FIG. 9.

FIG. 11 is a schematic view of a heat conducting lithium-ion battery in an eighth embodiment according to the present disclosure.

FIG. 12 is a cross-sectional view along line XII-XII of FIG. 11.

FIG. 13 is a schematic view of a heat conducting lithium-ion battery in a ninth embodiment according to the present disclosure.

FIG. 14 is a cross-sectional view along line XIV-XIV of FIG. 13.

FIG. 15 is a schematic view of a heat conducting lithium-ion battery in a tenth embodiment according to the present disclosure.

FIG. 16 is a schematic view of a heat conducting lithium-ion battery in an eleventh embodiment according to the present disclosure.

FIG. 17 is a schematic view of a heat conducting lithium-ion battery in a twelfth embodiment according to the present disclosure.

### DETAILED DESCRIPTION

Implementations of the disclosure will now be described, by way of embodiments only, with reference to the drawings.

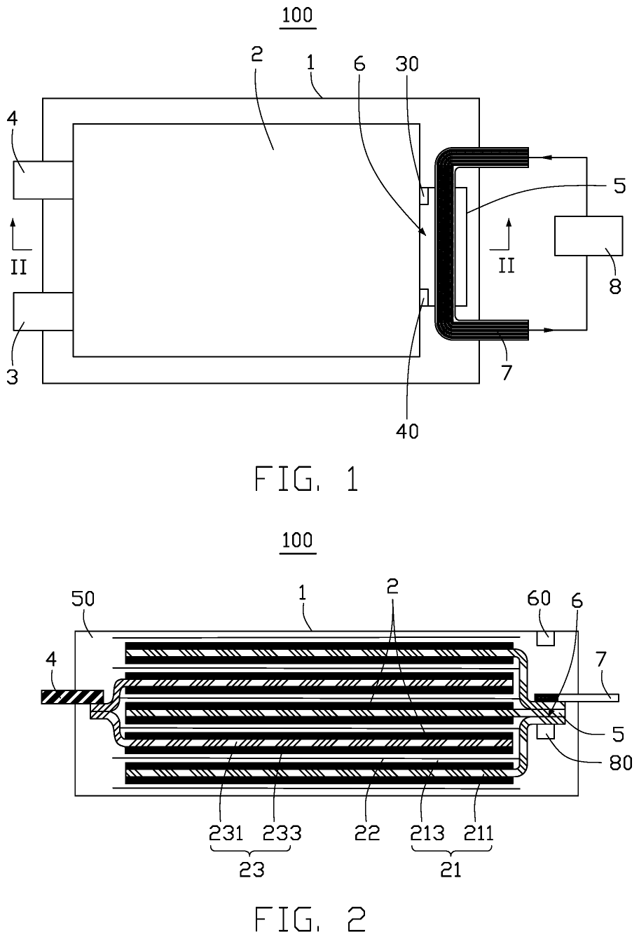

FIGS. 1 to 2 illustrate a first embodiment of a heat conducting lithium-ion battery 100 comprising a casing 1, a battery cell 2, a positive electrode tab 3, and a negative electrode tab 4. The positive tab 3 and the negative tab 4 can be arranged on a same side or different sides of the battery cell 2. The casing 1 encloses battery cell 2. The battery cell 2 comprises a positive electrode plate 21, a negative electrode plate 23, and a separator 22 spaced between the positive electrode plate 21 and the negative electrode plate 23. The positive electrode plate 21, the separator 22, and the negative electrode plate 23 are sequentially laminated or wound to form the battery cell 2. The negative electrode plate 23 comprises a negative current collector 231 and two negative active material layers 233 coated on the front and back sides of the negative current collector 231. The positive electrode plate 21 comprises a positive current collector 211 and two positive active material layers 213 coated on the front and back sides of the positive current collector 211. Either the positive electrode plate 21 or the negative electrode plate 23 further comprises a heat conducting and collecting body 5. The heat conducting and collecting body 5 is a portion of the positive current collector 211 not coated by the positive active material layer 213 or a portion of the negative current collector 231 not coated by the negative active material layer 233. At least two heat conducting and collecting bodies 5 are stacked together to form at least one heat converging path 6, which is configured to transmit heat energy into or out of the battery cell 2. The heat converging path 6 is stacked with or connected to a fluid-containing pipe 7.

Heat energy of the electrode plates, which are the main heating portions of the battery 100, can quickly converge on the heat converging path 6 through the heat conducting and collecting bodies 5, and then quickly exit out of the battery 100 through the fluid-containing pipe 7 arranged on the heat converging path 6, thus a high internal temperature of the battery 100 can be avoided. When an internal temperature of the battery 100 is too low, the heat converging path 6 can also be heated through the fluid-containing pipe 7, a suitable working temperature of the electrode plates can be quickly achieved, thereby maintaining the battery 100 in an optimal charge-discharge state, slowing down a fading capacity of the battery 100, and extending a service life of the battery 100. Also, by stacking the heat conducting and collecting bodies 5 to form the heat converging path 6 and heating/cooling the heat converging path 6, the internal temperature of the battery 100 is increased/decreased, thereby always maintaining the internal temperature of the battery 100 at a suitable working temperature, improving a working efficiency of the battery 100, extending a service life of the battery 100, and avoiding concomitant damage. An insulating member (not shown) is arranged on the heat converging path 6, thereby avoiding a short circuit of the battery 100 and improving a safety performance of the battery 100. The heat conducting and collecting body 5 can be integrally formed with the positive electrode plate 21, which simplifies the manufacturing process and increases the manufacturing efficiency.

In at least one embodiment, the heat conducting and collecting bodies 5 overlap with each other to form the heat converging path 6. The heat conducting and collecting bodies 5 are connected by welding to form the heat converging path 6. That is, the heat conducting and collecting bodies 5 can be connected together without any extra component. The welding can be ultrasonic welding, laser welding, or friction welding. In another embodiment, the heat conducting and collecting bodies 5 can also be connected by bolting or riveting.

Moreover, referring to FIG. 2, the heat conducting and collecting bodies 5 are bent towards each other to be connected. Therefore, the heat absorbed by the heat conducting and collecting bodies 5 is converged, which facilitates the dissipating of the heat from the battery 100 and the heating of the battery 100. The heat conducting and collecting bodies 5 after being bent can be perpendicular to the positive electrode plate 21 or the negative electrode plate 23. The heat conducting and collecting bodies 5 after being bent can be inclined with the positive electrode plate 21 or the negative electrode plate 23 by an angle of 0 to 89 degrees. The entirety of the heat conducting and collecting bodies 5 can be bent toward a single direction, which facilitates the connection of the heat conducting and collecting bodies 5. The heat conducting and collecting bodies 5 can also be bent toward different directions (for example, the bending direction of a portion of the heat conducting and collecting bodies 5 being opposite to that of the remaining heat conducting and collecting bodies 5). In other embodiments, a portion of the heat conducting and collecting bodies 5 are bent toward a single direction or different directions, and connected to the straight remaining (the unbent) heat conducting and collecting bodies 5.

In at least one embodiment, at least a portion of the heat conducting and collecting bodies 5 defines a plurality of holes (not shown). The holes can pass through the heat conducting and collecting body 5, and have a mesh structure or a 3D internal structure. In another embodiment, at least a portion of the heat conducting and collecting bodies 5 can have a concave and/or convex surface. As such, the heat conducting performance of the heat conducting and collecting body 5 is improved.

In at least one embodiment, the fluid-containing pipe 7 is connected to the heat converging path 7. Referring to FIGS. 1 and 2, the positive and negative electrode tabs 3 and 4 are arranged on the same side of the battery 100, the heat conducting and collecting bodies 5 and the fluid-containing pipe 7 are arranged on an opposite side of the battery 100 with respect to the positive and negative electrode tabs 3 and 4. The heat conducting and collecting bodies 5 are connected to the positive electrode tab 3. A first heat exchange device 8 outside of the casing 1 is connected to an inlet and an outlet of the fluid-containing pipe 7.

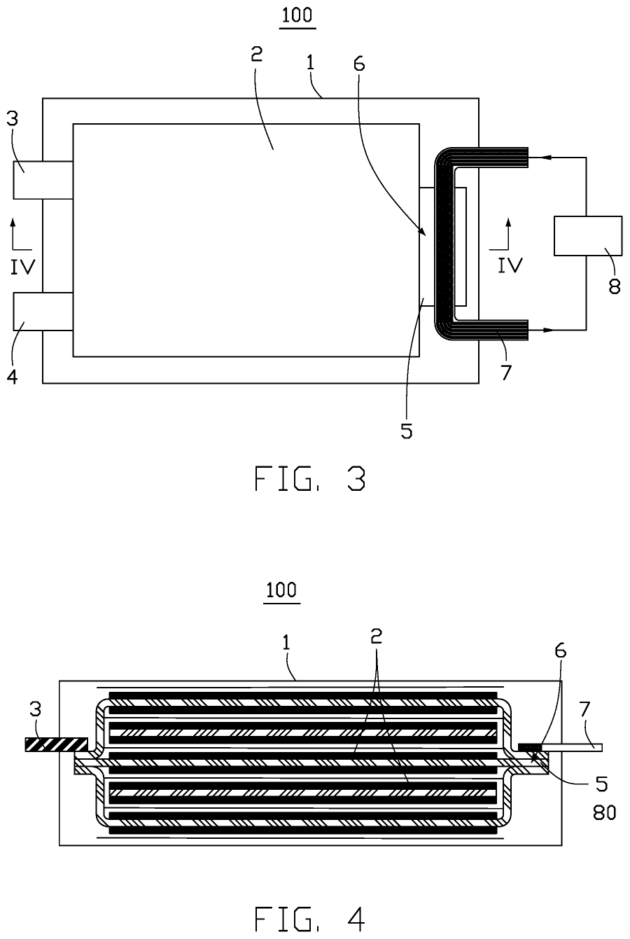

Referring to FIGS. 3 and 4, in a second embodiment, the positive and negative electrode tabs 3 and 4 are arranged on the same side of the battery 100, the heat conducting and collecting bodies 5 and the fluid-containing pipe 7 are arranged on an opposite side of the battery 100 with respect to the positive and negative electrode tabs 3 and 4. The heat conducting and collecting bodies 5 are connected to the negative electrode tab 4.

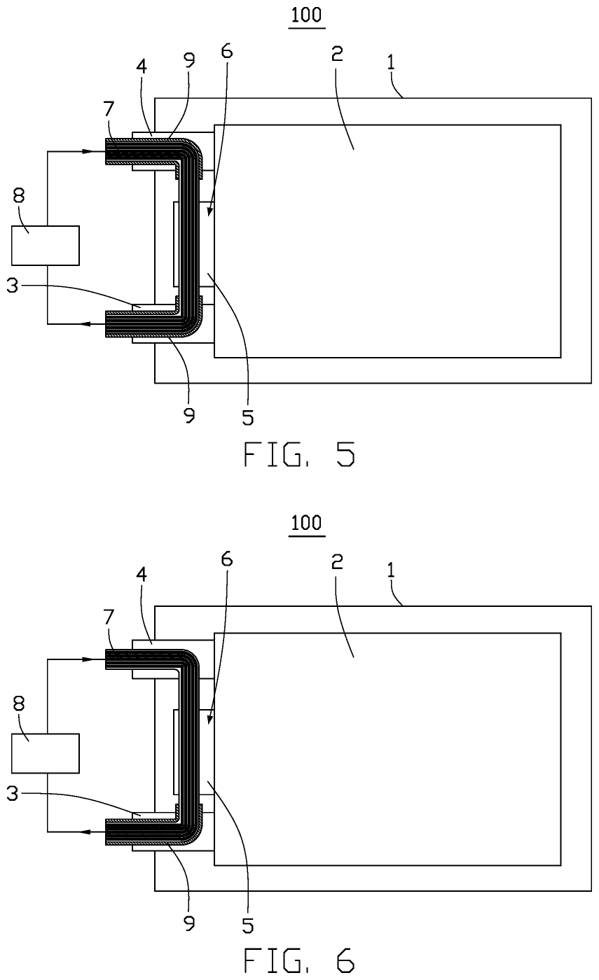

Referring to FIG. 5, in a third embodiment, the heat conducting and collecting bodies 5, the positive electrode tab 3, and the negative electrode tab 4 are arranged on the same side of the battery 100, the heat conducting and collecting bodies 5 being arranged between the positive electrode tab 3 and the negative electrode tab 4. The fluid-containing pipe 7 connected to the heat conducting and collecting bodies 5 enters into the battery 100 through a negative terminal post (not shown) and leaves the battery through a positive terminal post (not shown). An inlet and an outlet of the fluid-containing pipe 7 both carry an insulating layer 9 which insulates the fluid-containing pipe 7 from the positive and negative electrode tabs 3 and 4.

Referring to FIG. 6, in a fourth embodiment, the heat conducting and collecting bodies 5, the positive electrode tab 3, and the negative electrode tab 4 are arranged on the same side of the battery 100, the heat conducting and collecting bodies 5 being arranged between the positive electrode tab 3 and the negative electrode tab 4. The fluid-containing pipe 7 connected to the heat conducting and collecting bodies 5 enters into the battery 100 through a negative terminal post (not shown) and leaves the battery through a positive terminal post (not shown). The outlet of the fluid-containing pipe 7 carries the insulating layer 9 which insulates the fluid-containing pipe 7 from the positive electrode tabs 3.

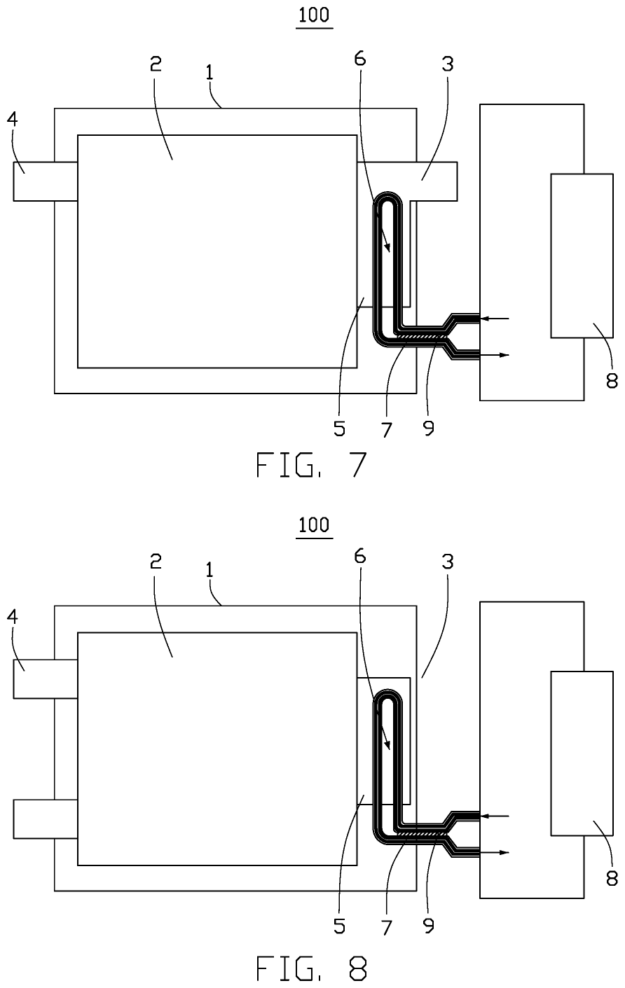

Referring to FIG. 7, in a fifth embodiment, the positive electrode tab 3 and the negative electrode tab 4 are arranged on opposite sides of the battery 100, the heat conducting and collecting bodies 5 and the positive electrode tab 3 are arranged on the same side of the battery 100. The heat conducting and collecting bodies 5 are connected to the positive electrode tab 3. The fluid-containing pipe 7 connected to the heat conducting and collecting bodies 5 enters and leaves the battery 100 through a single hole (not shown) defined on the battery 100. The inlet and the outlet of the fluid-containing pipe 7 both carry the insulating layer 9 which insulates the fluid-containing pipe 7 from the positive and negative electrode tabs 3 and 4.

Referring to FIG. 8, in a sixth embodiment, the positive electrode tab 3 and the negative electrode tab 4 are arranged the same side of the battery 100, the heat conducting and collecting bodies 5 and the positive and negative electrode tabs 3 and 4 are arranged on opposite sides of the battery 100. The heat conducting and collecting bodies 5 are connected to the positive electrode tab 3. The fluid-containing pipe 7 connected to the heat conducting and collecting bodies 5 enters and leaves the battery 100 through a single hole (not shown) defined on the battery 100. The inlet and the outlet of the fluid-containing pipe 7 both carry the insulating layer 9 which insulates the fluid-containing pipe 7 from the positive and negative electrode tabs 3 and 4.

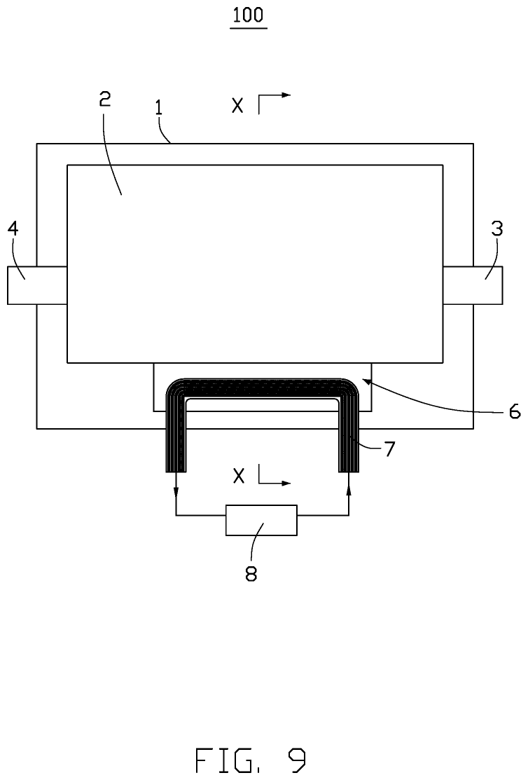

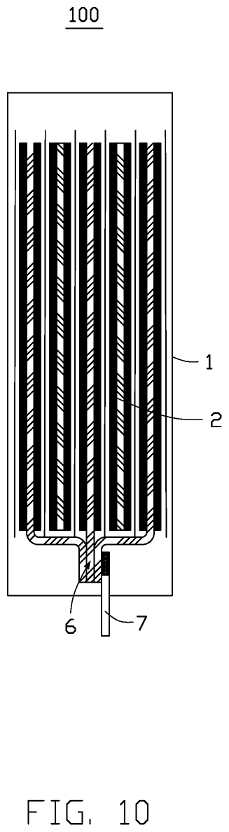

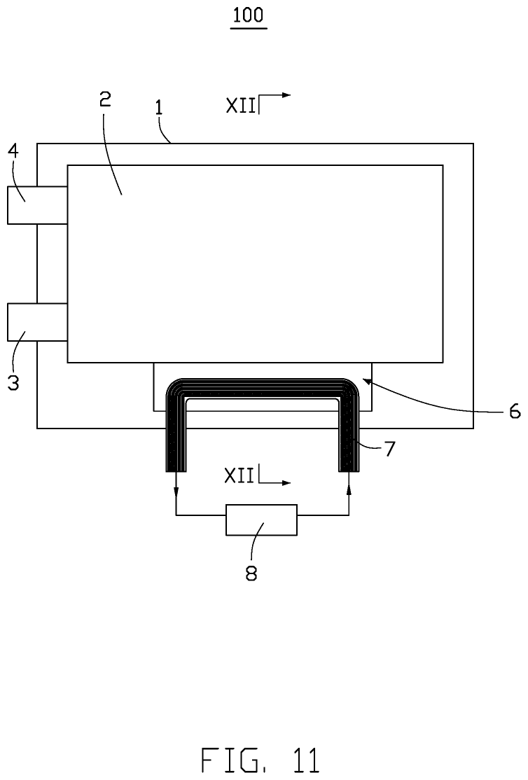

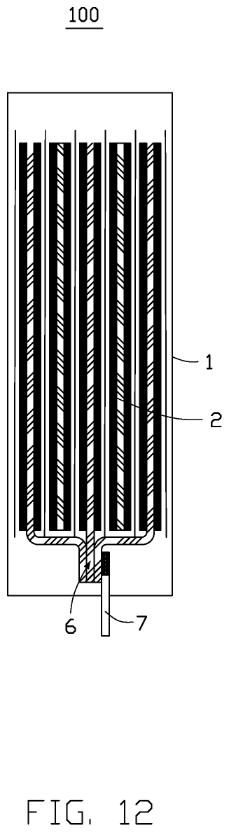

Referring to FIGS. 9 and 10, in a seventh embodiment, the positive electrode tab 3 and the negative electrode tab 4 are arranged on opposite sides of the battery 100, the heat conducting and collecting bodies 5 and the positive and negative electrode tabs 3 and 4 are arranged on different sides of the battery 100. The fluid-containing pipe 7 connected to the heat conducting and collecting bodies 5 enters and leaves the battery 100 from different holes defined on the battery 100.

Referring to FIGS. 11 and 12, in an eighth embodiment, the positive electrode tab 3 and the negative electrode tab 4 are arranged on the same side of the battery 100, the heat conducting and collecting bodies 5 and the positive and negative electrode tabs 3 and 4 are arranged on different sides of the battery 100. The fluid-containing pipe 7 connected to the heat conducting and collecting bodies 5 enters and leaves the battery 100 through different holes defined on the battery 100.

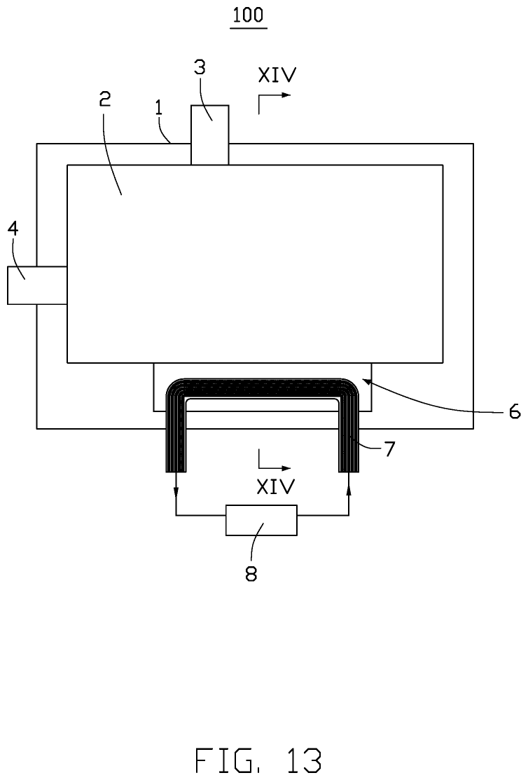

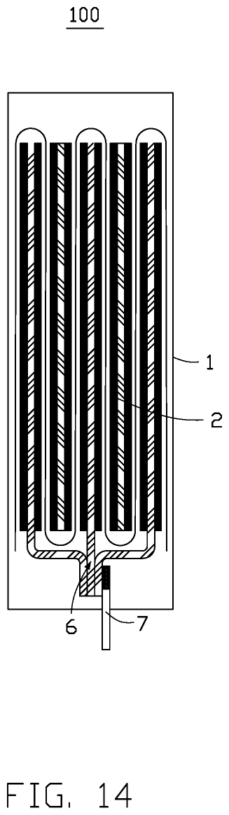

Referring to FIGS. 13 and 14, in a ninth embodiment, the positive electrode tab 3 and the negative electrode tab 4 are arranged on adjacent sides of the battery 100, the heat conducting and collecting bodies 5 and the positive electrode tab 3 are arranged on opposite sides of the battery 100. The fluid-containing pipe 7 connected to the heat conducting and collecting bodies 5 enters and leaves the battery 100 through different holes defined on the battery 100.

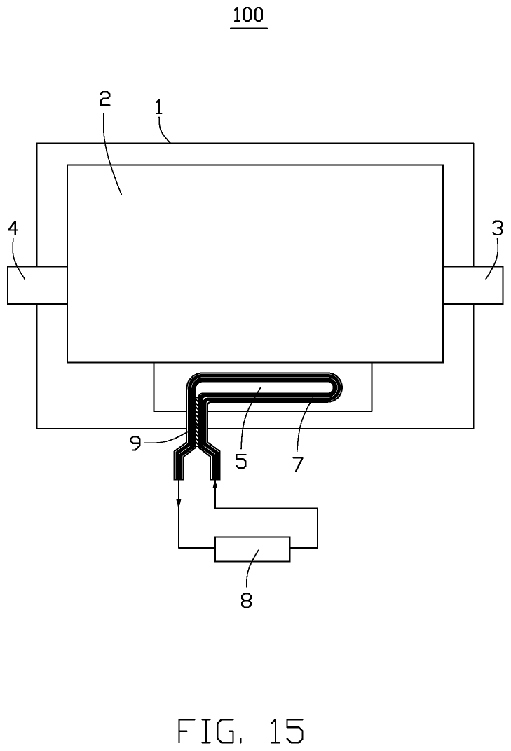

Referring to FIG. 15, in a tenth embodiment, the positive electrode tab 3 and the negative electrode tab 4 are arranged on the same side of the battery 100, the heat conducting and collecting bodies 5 and the positive and negative electrode tabs 3 and 4 are arranged on different sides of the battery 100. The fluid-containing pipe 7 connected to the heat conducting and collecting bodies 5 enters and leaves the battery 100 through a single hole defined on the battery 100. The insulating layer 9 is arranged between the inlet and the outlet of the fluid-containing pipe 7.

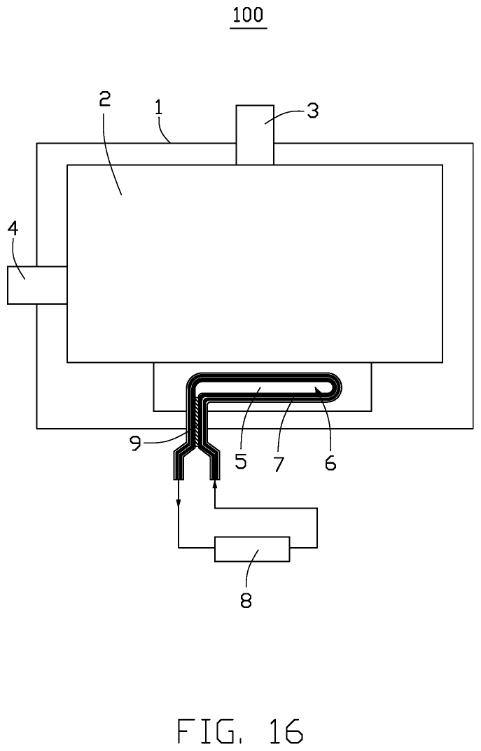

Referring to FIG. 16, in an eleventh embodiment, the positive electrode tab 3 and the negative electrode tab 4 are arranged on adjacent sides of the battery 100, the heat conducting and collecting bodies 5 and the positive electrode tab 3 are arranged on opposite sides of the battery 100. The fluid-containing pipe 7 connected to the heat conducting and collecting bodies 5 enters and leaves the battery 100 through a single hole defined on the battery 100. The insulating layer 9 is arranged between the inlet and the outlet of the fluid-containing pipe 7.

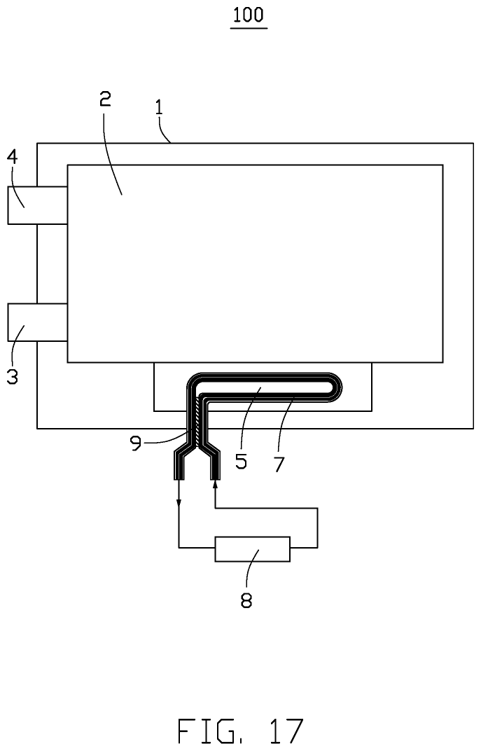

Referring to FIG. 17, in a twelfth embodiment, the positive electrode tab 3 and the negative electrode tab 4 are arranged on the same side of the battery 100, the heat conducting and collecting bodies 5 and the positive and negative electrode tabs 3 and 4 are arranged on different sides of the battery 100. The fluid-containing pipe 7 connected to the heat conducting and collecting bodies 5 enters and leaves the battery 100 through a single hole defined on the battery 100. The insulating layer 9 is arranged between the inlet and the outlet of the fluid-containing pipe 7.

Referring to FIG. 1, in at least one embodiment, the heat converging path 6 carries a heat dissipation member 30. The heat dissipation member 30 can be arranged between the heat conducting and collecting bodies 5. As such, the heat dissipation member 30 quickly conducts the heat energy into or out of the heat converging path 6. The heat dissipation member 30 can be multiple fins, a heat sink, or a metal sheet. The metal sheets quickly conduct the heat energy out of the heat converging path 11. The metal sheet and the heat conducting and collecting body 5 can be made of a single material, which facilitates the connection between the metal sheet and the heat conducting and collecting body 5.

Referring to FIG. 1, in at least one embodiment, a heat exchange member 40 is arranged on the heat converging path 6. The heat exchange member 40 maintains the temperature of the heat converging path 6 within a suitable range, thereby avoiding damage to the battery 100. The heat exchange member 40 can be connected to the heat converging path 6 by welding. That is, the heat converging path 6 and the heat exchange member 40 are connected together without any extra component, which also facilitates the connection. In another embodiment, the heat converging path 6 and the heat exchange member 40 can also be connected together by bolting, gluing, or riveting, which allows the connection to be stable. In another embodiment, the heat converging path 6 can also be directly connected to the casing 1. The casing 1 then serves as a heat sink to allow the heat energy on the heat converging path 6 to be delivered to the casing 1.

In at least one embodiment, the insulating layer 9 is arranged on a surface of the heat conducting and collecting body 5 or a surface of the heat converging path 6. As such, a short circuit in the battery 100 and concomitant damage can be avoided.

In at least one embodiment, when there is more than one heat converging path 6, the heat converging paths 6 can be arranged at a same side of the battery 100, for example, the heat converging paths 6 and the positive electrode tab 3 are arranged on the same side. The heat converging paths 6 can also be arranged at different sides of the battery 100. The heat converging paths 6 arranged at the side of the positive electrode tab 3 can be one or more.

In at least one embodiment, referring to FIG. 2, the heat conducting and collecting body 5 can protrude from the positive electrode plate 21, which facilitates the conduction and dissipation of the heat energy. The heat conducting and collecting body 5 protruding from the positive electrode plate 21 is further inserted into an electrolyte 50 received in the casing 1. As such, the heat energy from the heat conducting and collecting body 5 can be conducted into the electrolyte 50 and further to the external surface of the battery 100. Therefore, heat energy is prevented from being accumulated in the battery 100 due to poor heat conduction of the separator 22. Furthermore, the heat energy in the electrolyte 50 can further quickly move to the positive and the negative electrode plates 21 and 23, which prevents the temperature of the positive and the negative electrode plates 21 and 23 from being too low.

In at least one embodiment, referring to FIG. 2, a second heat exchange device 60 is arranged in the electrolyte 50 for heating or cooling the electrolyte 50. The electrolyte 50 can in turn heat or cool the heat conducting and collecting bodies 5, thereby maintaining the temperature of the battery 100 within a suitable range.

In at least one embodiment, the heat conducting and collecting body 5 can also be recessed with respect to the positive electrode plate 21, which saves internal space of the battery 100, and further increases the capacity of the battery 100 for a given size of casing.

In at least one embodiment, an interconnecting portion (not shown) is formed between the heat conducting and collecting body 5 and the positive electrode plate 21. A width of the heat conducting and collecting body 5 is the same as a width of the interconnecting portion. As such, the heat conducting property of the heat conducting and collecting body 5 is improved, and the manufacturing process is simplified.

In at least one embodiment, the positive current collector 211 not coated by the positive active material layer 213 can be parallel to the positive active material layer 213. In another embodiment, the portion of the positive current collector 211 not coated by the positive active material layer 213 can be on a central portion of the positive current collector 211.

In at least one embodiment, referring to FIGS. 1 and 2, a temperature sensor 80 is arranged on the heat converging path 6, which can sense the temperature of the heat converging path 6. The temperature sensor 80 can be a thin-film temperature sensor. In another embodiment, the temperature sensor 80 can also be arranged on the heat exchange member 40, which can sense the temperature of the heat exchange member 40.

In at least one embodiment, the positive active material of the positive active material layer 213 is lithium iron phosphate, lithium cobalt oxide, lithium manganate, or a ternary material. The negative active material of the negative active material layers 233 is carbon, tin-based negative material, or a transition metal nitride containing lithium or alloy.

Implementations of the above disclosure are described by way of embodiments only. It should be noted that devices and structures not described in detail are understood to be implemented by the general equipment and methods available in the art.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A heat conducting lithium-ion battery comprising:
a battery cell comprising a positive electrode plate and a negative electrode plate, the positive electrode plate comprising a positive current collector and a positive active material layer coated on the positive current collector, the negative electrode plate comprising a negative current collector and a negative active material layer coated on the negative current collector;
wherein at least one of the positive electrode plate and the negative electrode plate comprises two heat conducting and collecting bodies, each of the heat conducting and collecting bodies is a portion of the positive current collector which is not coated by the positive active material layer or a portion of the negative current collector which is not coated by the negative active material layer, at least two heat conducting and collecting bodies are stacked together to form at least one heat converging path, which is configured to transmit heat energy into or out of the battery cell, an fluid-containing pipe is connected to the at least one heat converging path.

2. The heat conducting lithium-ion battery of claim 1, wherein the at least two heat conducting and collecting bodies overlap with each other to form the at least one heat converging path.

3. The heat conducting lithium-ion battery of claim 2, wherein the at least two heat conducting and collecting bodies are connected by welding, bolting or riveting.

4. The heat conducting lithium-ion battery of claim 3, wherein a method of the welding comprises ultrasonic welding, laser welding, and friction welding.

5. The heat conducting lithium-ion battery of claim 1, wherein the at least two heat conducting and collecting bodies are bent towards each other.

6. The heat conducting lithium-ion battery of claim 5, wherein the at least two heat conducting and collecting bodies is bent to be inclined with the positive electrode plate by an angle between 0 degree to 90 degrees.

7. The heat conducting lithium-ion battery of claim 5, wherein the at least two heat conducting and collecting bodies are bent towards different directions or a single direction.

8. The heat conducting lithium-ion battery of claim 1, wherein a portion of each of the at least two heat conducting and collecting bodies is bent towards a single direction or different directions, and is connected to a remaining portion of a corresponding one of the at least two heat conducting and collecting bodies by welding, the remaining portion of the heat conducting and collecting bodies is straight.

9. The heat conducting lithium-ion battery of claim 1, wherein at least a portion of the at least two heat conducting and collecting bodies defines a plurality of holes or a concave and convex surface.

10. The heat conducting lithium-ion battery of claim 1, wherein a heat dissipation member is arranged on a surface of each of the at least one heat converging path, arranged on a surface of each of the at least two heat conducting and collecting bodies, or arranged between the at least two heat conducting and collecting bodies.

11. The heat conducting lithium-ion battery of claim 10, wherein the heat dissipation member comprises fins, a heat sink, and a metal sheet, a material of the metal sheet is the same as a material of the heat conducting and collecting body.

12. The heat conducting lithium-ion battery of claim 1, wherein a heat exchange member is connected to the at least one heat converging path by welding, bolting, gluing, or riveting.

13. The heat conducting lithium-ion battery of claim 1, wherein an insulating layer is arranged on a surface of the heat conducting and collecting body or a surface each of the at least one heat converging path.

14. The heat conducting lithium-ion battery of claim 1, wherein the at least one heat converging path is arranged on an end of the heat conducting lithium-ion battery, the end of the heat conducting lithium-ion battery having a positive electrode tab, an end of the heat conducting lithium-ion battery opposite to the positive electrode tab, or a side of the heat conducting lithium-ion battery.

15. The heat conducting lithium-ion battery of claim 14, wherein the heat conducting and collecting bodies form a plurality of heat converging paths, at least one of the heat converging paths is arranged on the end of the heat conducting lithium-ion battery having the positive electrode tab.

16. The heat conducting lithium-ion battery of claim 1, wherein each of the at least two heat conducting and collecting bodies protrudes from the positive electrode plate, and a portion of each of the at least two heat conducting and collecting bodies which protrudes from the positive electrode plate is inserted into an electrolyte of the heat conducting lithium-ion battery, a heat exchange device is arranged in the electrolyte for heating or cooling the electrolyte.

17. The heat conducting lithium-ion battery of claim 1, wherein each of the at least two heat conducting and collecting bodies is recessed with respect to the positive electrode plate.

18. The heat conducting lithium-ion battery of claim 1, wherein an interconnecting portion is formed between the conducting and collecting body and the positive electrode plate, a width of the heat conducting and collecting body is the same as a width of the interconnecting portion.

19. The heat conducting lithium-ion battery of claim 1, wherein a temperature sensor is arranged on each of the at least one heat converging path.

20. The heat conducting lithium-ion battery of claim 1, wherein the heat conducting lithium-ion battery further comprising a casing directly connected to the at least one heat converging path, the casing is a heat sink for the positive electrode plate and the negative electrode plate.
